(19) United States
(12) Patent Application Publication
(10) Pub. No.: US 2022/0379549 A1
(43) Pub. Date: Dec. 1, 2022

(54) USE OF CAST-POLYAMIDE FILAMENT AND CAST-POLYAMIDE GRANULAR MATERIAL FOR ADDITIVE MANUFACTURING, AND PRODUCTION PROCESS

(71) Applicant: Elkamet Kunststofftechnik GmbH, Biedenkopf (DE)

(72) Inventors: Marco Emrich, Ulrichstein (DE); Eberhard Flammer, Biedenkopf (DE); Martin Neebe, Stadtallendorf (DE)

(21) Appl. No.: 17/773,850

(22) PCT Filed: Nov. 12, 2020
(86) PCT No.: PCT/DE2020/100964

§ 371 Date: May 3, 2022

(30) Foreign Application Priority Data
Nov. 18, 2019 (DE) 10 2019 131 083.0

(51) Int. Cl. B29C 64/118; B33Y 10/00; B33Y 70/00; C08G 69/14; C08L 77/02

(52) U.S. Cl. CPC B29C 64/118; B33Y 10/00; B33Y 70/00; C08G 69/14; C08L 77/02; B29K 2077/00

(57) ABSTRACT

A method for producing an object by additive manufacturing using a polyamide filament includes performing the additive manufacturing using the polyamide filament and a fused deposition modeling process. The polyamide is a cast polyamide. Advantageously, it is possible that the polyamide can have a Young's modulus in tension of 3,300 MPa to 4,000 MPa, and/or a heat-distortion temperature HDT A of 80° C. to 150° C. and/or a heat-distortion temperature HDT B of 180° C. to 240° C., and/or a yield stress of 85 MPa to 100 MPa and/or a Vicat softening temperature VST/B/50 of 208° C. to 220° C. Advantageously, it is possible that the polyamide can include a polyamide 6, a polyamide 12, a blend thereof, or a copolymer thereof.

### CROSS-REFERENCE TO PRIOR APPLICATIONS

This application is a U.S. National Phase application under 35 U.S.C. § 371 of International Application No. PCT/DE2020/100964, filed on Nov.12, 2020, and claims benefit to German Patent Application No. DE 10 2019 131 083.0, filed on Nov. 18, 2019. The International Application was published in German on May 27, 2021 as WO 2021/098910 A1 under PCT Article 21(2).

### FIELD

The invention relates to the use of cast-polyamide filaments and cast-polyamide pellets for additive manufacturing using a fused deposition modeling process. The invention further relates to a process for producing an object by additive manufacturing using a cast-polyamide filament or cast-polyamide pellets.

### BACKGROUND

EP 2662199 A1 describes the use of powdered polyamide 12, powdered polyamide 11, and powdered polyamide 613 for additive manufacturing by selective laser sintering.

Cast polyamides are polyamides which are produced by anionic polymerization and have higher molecular weights than extrusion and injection-molding types of the respective polyamides, which are generally produced by hydrolytic polymerization of lactams or by polycondensation of amino acids. The production of cast polyamides, for example of cast polyamide 6, by anionic polymerization of lactam is known and described, for example, in DE 102014106998 A1, DE 102014111685 A1, and DE 102015106042 A1.

For example, a cast polyamide 6 has a higher molecular weight than an extrusion-type polyamide 6. Therefore, cast polyamides have advantageous properties as compared to polyamides which are used for extrusion or injection molding.

For example, cast polyamides have a higher yield stress, a higher Young's modulus in tension, and a higher Vicat softening temperature than extrusion-type polyamides. In particular, the dimensional stability under heat, also referred to as the short-term thermal stability, is increased in cast polyamides.

Other well-known advantages of cast polyamides over extrusion-type polyamides are higher molecular weight, higher crystallinity, less tendency to creep, increased tensile strength, hardness and stiffness, high abrasion resistance and higher stability and stiffness under the action of heat (Domininghaus; Kunststoffe: Eigenschaften and Anwendung [Plastics: properties and applications]; Springer (2012); 701).

### SUMMARY

In an embodiment, the present invention provides a method for producing an object by additive manufacturing using a polyamide filament includes performing the additive manufacturing using the polyamide filament and a fused deposition modeling process. The polyamide is a cast polyamide.

### BRIEF DESCRIPTION OF THE DRAWINGS

Subject matter of the present disclosure will be described in even greater detail below based on the exemplary figure. All features described and/or illustrated herein can be used alone or combined in different combinations. The features and advantages of various embodiments will become apparent by reading the following detailed description with reference to the attached drawing, which illustrates the following:

FIG. 1 illustrates the production of cast-polyamide filament and subsequent use in additive manufacturing according to an embodiment of the present invention.

### DETAILED DESCRIPTION

The polyamides usually used for additive manufacturing have the disadvantage of having limited dimensional stability under heat.

In order to achieve improved dimensional stability under heat, cast polyamides are often used in forming processes.

Another disadvantage is that the polyamides used for additive manufacturing are usually in the form of virgin material. In contrast, the polyamide reject material arising during the production of polyamide parts remains unused and is introduced into the waste cycle.

It is also a disadvantage that additive manufacturing by fused deposition modeling with polyamides requires heating of the building chamber and the printing bed.

Yet another disadvantage is the high shrinkage behavior of polyamides, which makes additive manufacturing more difficult.

Embodiments of the present invention achieve improvements over the prior art.

Such improvements are achieved in accordance with embodiments of the present invention by using a cast-polyamide filament for additive manufacturing by fused deposition modeling. Such improvements are also achieved in accordance with embodiments of the present invention by a process for producing an object by additive manufacturing using a cast-polyamide filament, the additive manufacturing being performed using a fused deposition modeling process.

Cast polyamides are polyamides which are produced by anionic polymerization of precursors with the addition of a catalyst and generally of an activator. Examples of such polyamides include polyamide 6 (PA6) or polyamide 12 (PA12), with caprolactam being used as a precursor for the manufacture of PA6 and laurolactam being used as a precursor for the manufacture of PA12. Cast polyamides within the scope of embodiments of the invention include, in addition to polyamide 6 and polyamide 12, blends containing polyamide 6 and polyamide 12 or copolymers containing polyamide 6 and polyamide 12. Polyamide 6 is particularly preferred. Cast polyamides are often produced and shaped simultaneously in a stationary casting process, a spin-casting process, or a rotational casting process.

The particular advantage of using cast-polyamide filaments lies in the preservation of a higher molecular weight, which is typical of cast polyamides as compared to filaments made of extrusion-type polyamides.

As a result, the properties typical of cast polyamides are also preserved. Examples of these properties include higher dimensional stability under heat, higher yield stress, a higher Young's modulus, and a higher Vicat softening temperature as compared to extrusion-type polyamides.

The production of cast-polyamide filaments for additive manufacturing by fused deposition modeling can be carried out by crushing parts made of cast polyamide, such as plates or round bodies.

In addition to cast polyamides produced specifically for extrusion, recycled material can also be used. The material to be recycled is, for example, residual material, reject material, or used material. In this connection, care must be taken to ensure that the material to be recycled is of a single type. The crushing process produces cast-polyamide pieces with a size of 1 mm to 50 mm, preferably 5 mm to 40 mm, more preferably 5 mm to 30 mm, and especially preferably 6 mm to 12 mm. Depending on the properties of the extruder intended for further processing, the cast-polyamide pieces obtained may additionally be ground. In such process, sizes of 0.3 mm to 6 mm can be obtained.

The optionally ground cast polyamide so obtained constitutes the feedstock for the extrusion process. Unless degassing takes place during extrusion, the feedstock should be pre-dried. This can usually be done at 80° C. for 4 hours. It is also possible to perform pre-drying at 100° C. for 4 days.

Alternatively, it is also possible to use powdered cast polyamide produced by known methods through anionic polymerization in a spray tower. This method is described, for example, in EP 2460838 A1.

In a conventional process, the extrusion is carried out at an extruder temperature which is 40° C. to 100° C. above the melting temperature of the cast polyamide used. For example, in the case of PA6, temperatures of 260° C. to 280° C. or 270° C. to 275° C. may be used, for example temperatures of 260° C., 265° C., 270° C., 275° C. and 280° C., each with a tolerance of ±2.5° C. Furthermore, optionally, degassing is performed during extrusion.

Furthermore, the extrusion can optionally also be carried out under a nitrogen atmosphere, especially in the absence of oxygen. During extrusion, additives may be added to the material, such as, for example, heat stabilizers, UV stabilizers, fillers or reinforcing materials (glass fibers, carbon fibers, carbon nanotubes, etc.) or processing aids, such as lubricating agents or the like.

In the process, the cast polyamide may be extruded into a filament suitable for additive manufacturing, the shape of which is arbitrary and can therefore be, for example, round or polygonal, with a diameter of 1 mm to 10 mm, for example a diameter of 1 mm, 1.5 mm, 1.75 mm, 2 mm, 2.5 mm, 2.80 mm, 2.85 mm, 2.90 mm, 2.95 mm, 3 mm, 4 mm, 4.5 mm, 5 mm, 5.5 mm, 6 mm, 6.5 mm, 7 mm, 7.5 mm, 8 mm, 8.5 mm, 9 mm, 9.5 mm or 10 mm. For all of the above values, a tolerance of ±20% may apply so that, for example, “1 mm” covers the range from 0.8 mm to 1.2 mm.

The term “diameter” is not to be understood in a strictly mathematical sense to mean that the filament must have a perfectly round cross section. Rather, in the case of non-round cross sections, it can be understood in the sense of an average of a maximum and a minimum cross-sectional extent.

Extruded filaments can also be pelletized to a size of, for example, 3 mm using a strand pelletizer and be used as cast-polyamide pellets for other forming processes, such as extrusion, injection molding, and thermoforming.

Alternatively, the anionic polymerization may also only take place in situ in the extruder during the extrusion process. In this case, the precursors required for anionic polymerization, such as caprolactam, activator and catalyst are fed into the extruder, optionally with the addition of additives, and polymerized to polyamide at a suitable temperature and in particular under a nitrogen atmosphere, and the polyamide just formed is then extruded under the above conditions. This process is also known as “reactive extrusion.”

In addition to the extrusion of filaments, the above mentioned process can also be used to produce extrudates that differ in shape from the filaments.

The cast-polyamide filament used in accordance with an embodiment of the invention for additive manufacturing or used in the production process of an embodiment of the invention, as well as the above-mentioned cast-polyamide pellets, which can be produced using, for example, the above process, exhibit(s) improved mechanical properties as compared to the extrusion-type polyamide typically used for fused deposition modeling. The cast-polyamide filament may have the properties described below.

For dry test specimens, the cast-polyamide filament and the cast-polyamide pellets have a yield stress according to ISO 527 of at least 80 MPa, preferably of 85 MPa to 100 MPa, for example of at least 85 MPa, 90 MPa, 95 MPa, or 97 MPa, respectively.

The Young's modulus in tension of the cast-polyamide filament and of the cast-polyamide pellets for dry test specimens according to ISO 527 (5 mm/min) is at least 3000 MPa, preferably 3300 MPa to 4000 MPa, for example at least 3300 MPa, 3400 MPa, 3500 MPa, 3600 MPa, 3700 MPa, 3800 MPa, 3900 MPa, or 3950 MPa, respectively.

The heat-distortion temperature HDT A of the cast-polyamide filament and of the cast-polyamide pellets for dry test specimens according to ISO 75 is at least 65° C., preferably 80° C. to 150° C., for example at least 80° C., 85° C., 90° C., 95° C., 100° C., 105° C., 110° C., 115° C., 120° C., 125° C., 130° C., 135° C., 140° C., 145° C., or 147° C., respectively.

The heat-distortion temperature HDT B of the cast-polyamide filament and of the cast-polyamide pellets for dry test specimens according to ISO 75 is at least 160° C., preferably 180° C. to 240° C., for example at least 180° C., 185° C., 190° C., 195° C., 200° C., 205° C., 210° C., 215° C., 220° C., 225° C., 230° C., 235° C., or 237° C., respectively.

The Vicat softening temperature VST/B/50 of the cast-polyamide filament and of the cast-polyamide pellets for dry test specimens according to ISO 306 is at least 205° C., preferably 208° C. to 220° C., for example at least 208° C., 209° C., 210° C., 215° C., or 217° C., respectively.

As already explained above, the cast-polyamide filament used in accordance with an embodiment of the invention for additive manufacturing or used in the production process of an embodiment of the invention may in particular be made from a residual material, a reject material, or a used material or include a residual material, a reject material, or a used material.

For additive manufacturing using the fused deposition modeling process according to an embodiment of the invention, the extruded filament made of cast polyamide or also the above-mentioned cast-polyamide pellets is/are introduced into a suitable nozzle, and the nozzle is operated at a temperature of 40° C. to 100° C. above the melting temperature of the cast polyamide. In the case of PA6, the nozzle temperature is at least 260° C., in particular 280° C. to 310° C. Specifically, the nozzle temperature may be 260° C., 270° C., 280° C., 285° C., 290° C., 295° C., 300° C., 305° C., or 310° C. A nozzle temperature of 295° C. is preferred. A tolerance of ±2.5° C. is to apply to each of the values mentioned.

Surprisingly, it was found that due to the higher molecular weight and the higher melt viscosity of cast polyamides as compared to extrusion-type polyamides, a higher nozzle temperature can be used without the initial stability of the material deposited in the fused deposition modeling process being too low in the hot state (which would cause the material to “flow away” and would not allow the building of dimensionally accurate 3D objects).

Due to the higher nozzle temperature, the deposited material has a higher temperature, which improves the interlayer adhesion between successive layers. This eliminates the need to heat the building space and/or the printing bed. Therefore, additive manufacturing by fused deposition modeling with polyamides can be performed at a building chamber temperature and/or at a printing bed temperature substantially equal to room temperature.

An embodiment of the invention also encompasses a process for producing an object by additive manufacturing in a fused deposition modeling process using a cast-polyamide filament. With regard to suitable cast-polyamide filaments and suitable process parameters, reference is made to the above explanations.

The products produced by fused deposition modeling from cast-polyamide filaments or from suitable cast-polyamide pellets in accordance with the process described above are characterized by improved mechanical properties as compared to products produced by fused deposition modeling from extrusion-type polyamides. Examples of such properties include higher yield stress, higher Young's modulus, and higher dimensional stability under heat. In particular, it is preferred that the products produced have the same or comparable mechanical properties as the cast-polyamide filaments or the cast-polyamide pellets used.

For example, a product produced according to an embodiment of the invention from cast-polyamide filament in accordance with the parameters specified above for the fused deposition modeling process has one or more of the following characteristics:

For dry test specimens, the product produced has a yield stress according to ISO 527 of at least 80 MPa, preferably of 85 MPa to 100 MPa, for example of at least 85 MPa, 90 MPa, 95 MPa, or 97 MPa, respectively.

The Young's modulus in tension of the product produced for dry test specimens according to ISO 527 (5 mm/min) is at least 3000 MPa, preferably 3300 MPa to 4000 MPa, for example at least 3300 MPa, 3400 MPa, 3500 MPa, 3600 MPa, 3700 MPa, 3800 MPa, 3900 MPa, or 3950 MPa, respectively.

The heat-distortion temperature HDT A of the product produced for dry test specimens according to ISO 75 is at least 65° C., preferably 80° C. to 150° C., for example at least 80° C., 85° C., 90° C., 95° C., 100° C., 105° C., 110° C., 115° C., 120° C., 125° C., 130° C., 135° C., 140° C., 145° C., or 147° C., respectively.

The heat-distortion temperature HDT B of the product produced for dry test specimens according to ISO 75 is at least 160° C., preferably 180° C. to 240° C., for example at least 180° C., 185° C., 190° C., 195° C., 200° C., 205° C., 210° C., 215° C., 220° C., 225° C., 230° C., 235° C., or 237° C., respectively.

The Vicat softening temperature VST/B/50 of the product produced for dry test specimens according to ISO 306 is at least 205° C., preferably 208° C. to 220° C., for example at least 208° C., 209° C., 210° C., 215° C., or 217° C., respectively.

It should also be pointed out that the molecular weight of the cast polyamide which is used for additive manufacturing, used in such a production process and/or contained in an object produced therefrom is higher than the molecular weight of extrusion-type polyamides.

### EXAMPLES

The following description of the production of filaments from cast polyamide 6 and their use in fused deposition modeling represents a first example, which is in no way limiting to the invention.

Initially, a container of any geometry was produced from cast polyamide 6 in a rotational casting process. To this end, in known manner, caprolactam, an activator, and a catalyst were initially injected into the rotational mold, and the rotational mold was rotated while supplying heat thereto. During rotation, the anionic polymerization of the starting materials into cast polyamide 6 occurred simultaneously with the formation of the container.

Formulations and more detailed process descriptions are known to those skilled in the art and shown by way of example in publication DE102014106998A1.

The residual material that arises during container production (e.g., cutouts to form container openings and the like) and contains the cast polyamide 6 was collected as a single-type material and crushed to a size of 6 mm to 12 mm.

The pieces so obtained were then ground to a size of 0.3 mm to 3 mm.

The ground material composed of cast polyamide 6 was then introduced into a single-screw extruder. A cast-polyamide filament having a diameter of 2.85 mm was produced at an extruder temperature of 260° C. with degassing being performed during the process.

The filament so obtained was subsequently used in a fused deposition modeling (FDM) process for additive manufacturing. In this process, the nozzle used had a nozzle temperature of about 290° C.

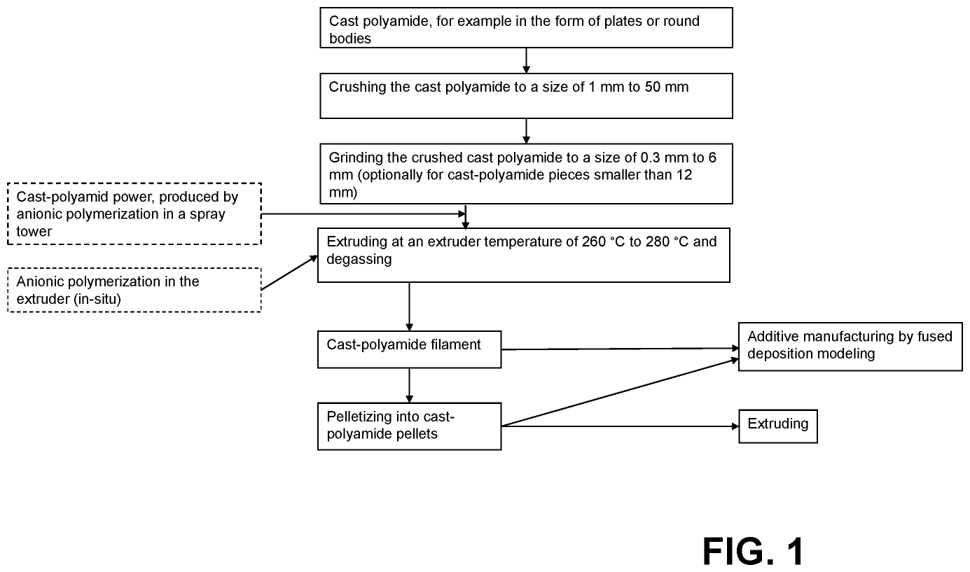

The method is further illustrated in FIG. 1.

In another non-limiting example, the molecular weight of the cast-polyamide filament was investigated.

A cast polyamide 6 produced by anionic polymerization, which usually has a number average molecular weight (Mn) of 180,000-230,000 g/mol, was ground to a material which was determined to have a molecular weight (Mn) of 192,000 g/mol.

In the next process step, the ground cast polyamide 6 was extruded at a barrel temperature of 260° C. −290° C. with degassing being performed during the process. The resulting cast-polyamide filament showed a molecular weight (Mn) of 62,000 g/mol.

The material of the product produced from the cast-polyamide filament by additive manufacturing was determined to have a molecular weight (Mn) of 68,000 g/mol. This value is 3 to 5 times higher than the molecular weight of conventional injection-molded polyamide 6 and provides the additively manufactured product with the advantageous properties mentioned above.

A test specimen (ISO 527, type 1b) was produced by additive manufacturing by fused deposition modeling using the cast-polyamide filament. The dry test specimen was determined to have a Young's modulus of 3,800 MPa.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1.-8 (canceled)

9. A method for producing an object by additive manufacturing using a polyamide filament comprising a polyamide, the method comprising:
performing the additive manufacturing using the polyamide filament and a fused deposition modeling process, wherein the polyamide is a cast polyamide.

10. The method as recited in claim 9, wherein the polyamide has a Young's modulus in tension of 3,300 MPa to 4,000 MPa.

11. The method as recited in claim 9, wherein the polyamide has a heat-distortion temperature HDT A of 80° C. to 150° C. and/or a heat-distortion temperature HDT B of 180° C. to 240° C.

12. The method as recited in claim 9, wherein the polyamide has a yield stress of 85 MPa to 100 MPa and/or a Vicat softening temperature VST/B/50 of 208° C. to 220° C.

13. The method as recited in claim 9, wherein the polyamide includes a polyamide 6, a polyamide 12, a blend including polyamide 6 and polyamide 12, or a copolymer including polyamide 6 and polyamide 12.

14. The method as recited in claim 9, wherein the polyamide filament is made from a residual material, a reject material, or a used material,. or wherein the polyamide filament includes a residual material, a reject material, or a used material.

15. The method as recited in claim 9, wherein a nozzle used in the fused deposition modeling process has a nozzle temperature of 280° C. to 310° C.

16. The method as recited in claim 9, wherein, during the fused deposition modeling process, a building chamber temperature and/or a printing bed temperature are/is substantially equal to room temperature.

17. An object produced by the method according to claim 9.

18. (canceled)

19. The object as recited in claim 17, wherein the polyamide has a Young's modulus in tension of 3,300 MPa to 4,000 MPa.

20. The object as recited in claim 17, wherein the polyamide has a heat-distortion temperature HDT A of 80° C. to 150° C. and/or a heat-distortion temperature HDT B of 180° C. to 240° C.

21. The object as recited in claim 17, wherein the polyamide has a yield stress of 85 MPa to 100 MPa and/or a Vicat softening temperature VST/B/50 of 208° C. to 220° C.

22. The object as recited in claim 17, wherein the polyamide includes a polyamide 6, a polyamide 12, a blend including polyamide 6 and polyamide 12, or a copolymer including polyamide 6 and polyamide 12.

23. The object as recited in claim 17, wherein the polyamide filament is made from a residual material, a reject material, or a used material, or wherein the polyamide filament includes a residual material, a reject material, or a used material.

24. The object as recited in claim 17, wherein a nozzle used in the fused deposition modeling process has a nozzle temperature of 280° C. to 310° C.

25. The object as recited in claim 17, wherein, during the fused deposition modeling process, a building chamber temperature and/or a printing bed temperature are/is substantially equal to room temperature.
